(19) United States
(12) Patent Application Publication
(10) Pub. No.: US 2005/0108059 A1
(43) Pub. Date: May 19, 2005

(54) Portable health data system

(76) Inventor: Howard P. Tay, Glendale, AZ (US)

Correspondence Address: GREENBERG TRAURIG LLP, 2450 COLORADO AVENUE, SUITE 400E, SANTA MONICA, CA, 90404, US

(21) Appl. No.: 10/975,204

(22) Filed: Oct. 27, 2004

Related U.S. Application Data
(60) Provisional application No. 60/515,998, filed on Oct. 31, 2003.

(51) Int. Cl. G06F 17/60

(52) U.S. Cl. 705/3

(57) ABSTRACT

A portable health storage device to be carried by a user is portable and includes a user's medical information for use in a health data system. There is a main circuit board; a memory circuit board connected to the main circuit board; and a serial bus port. An intermediate electronic system is connectable with the portable health data storage device. A database on a remote server is connectable with the intermediate electronic system and a health care facility database. This is connectable with the intermediate electronic system. The medical information is updateable, initially or during use, through connection of the portable health data storage device with at least one database through the intermediate electronic system. The device is a JumpDrive portable USB storage device.

### RELATED APPLICATION

This application relates to U.S. provisional application No. 60/515,998 filed Oct. 31, 2003, entitled Portable Health Data System, the contents of which are incorporated by reference herein.

### BACKGROUND OF THE DISCLOSURE

1. Field of the Disclosure

The present disclosure relates to devices systems and methods for storing and transferring medical information.

2. General Background and State of the Art

Simplicity and practicality are often desirable in devices systems and methods that concern medical information.

A significant portion of the public is not in fact able to easily handle medical information. For example people often forget medical diagnosis or surgical procedures, cannot recall a current medication or drug allergies and are not aware of possible drug prophylaxis needs associated with medical treatments such as, for example, transplants or application of a prosthesis.

Prompt availability of all this information is a critical in most situations where a medical treatment is provided to a patient.

In this respect also the communication between health care providers is often made difficult because of the different languages and standards used by health systems and providers such as hospitals, laboratories, pharmacies etc. For example access to lab results, radiographic studies doctor visits or summary or list of diagnosis of a patient is often made difficult for a treating physician, with significant costs in term of time spent in obtaining information and safety of the patient.

### SUMMARY OF THE DISCLOSURE

An object of the present disclosure is to provide a portable health data storage device (PDSD) for storing carrying and transferring medical information concerning a patient.

A portable health storage device for a patient is for use in a portable health data system. The system may include an intermediate electronic system connectable with the portable health data storage device. There can be a database on a remote server, connectable with the intermediate electronic system; and a health care facility database, connectable with the intermediate electronic system.

The portable health data storage device can comprise a memory connectable to an input/output facility. The portable health data storage device is intended to be carried by a patient; and the portable health data storage device is for carrying medical information related to the patient.

The medical information is updateable, initially or during use, through connection of the portable health data storage device with at least one database through the intermediate electronic system.

According to one aspect the disclosure there is a portable health data storage device suitable to be used in a portable health data system. The system comprises a portable health data storage device to be carried by a user having a main circuit board, a memory circuit board connected to the main circuit board and a serial bus port mounted at one end of the main circuit board. The port may be capable of being pivoted so as to permit the mounting to be turned relative to the main circuit board for a limited angle.

The system includes also an intermediate electronic system connectable with the portable health data storage device. A database on a remote server, and a health care facility database are also connectable with the intermediate electronic system.

The portable health data storage device carries medical information related to the user. The medical information is updateable, initially or during use, through connection of the portable health data storage device with at least one database through the intermediate electronic system.

According to a second aspect, there is also a PDSD suitable to be used in a method for carrying personal medical information on a portable health data storage device. There is a main circuit board, a memory circuit board connected to the main circuit board and a serial bus port mounted at one end of the main circuit board. The port in some cases can be movable and more particularly capable of being turned relative to the main circuit board for a limited angle.

The method comprises the steps of initializing and updating the portable health data storage device through upload of the personal medical information to the portable health data storage device by means of information stored on databases remote from the portable health data storage device. The upload is affected by connecting the device through a computer to a database.

The portable health storage device is preferably a JumpDrive portable USB storage device. A JumpDrive device is well known as a portable memory unit easily connectable with the universal serial bus (USB) port in a computer, and not requiring special drivers in the computer system so as to be readable, accessed or loaded by the computer.

A first advantage of the PDSD is the possibility of storing all the data pertaining to a patient, including radiographic readings and studies, in a single device, which can easily be carried, as may be needed which in some cases may be essentially everywhere, by the user.

A second advantage of the PDSD is the possibility for a patient of promptly providing a lot, most or all of the patient's medical information at a moments notice.

A third advantage of the PDSD is the possibility of allowing an effortless transfer of medical files between many, and some cases every, computer system (for instance, between PC and Mac) with little, and in most cases no, extra step and with little, and in most cases, no specific need to require a driver installation.

The disclosure also includes a Portable Health Data (PHD) system that includes the PDSD. When the portability of the PHD is considered in this sense there is preferably meant the ability to electronically, optically or electro magnetically permit carrying or permit transferring directly or indirectly of the health data of a patient through the direct or indirect use or application of the PDSD. The portability of the PHD refers to the web based/intermediate system.

The PHD system is a hardware/software system that allows translation of existing health data from different computer systems of health systems and providers such as hospitals, laboratories, etc. into a universal data format to be stored in a portable health data storage device (PDSD) to be carried by the patient.

There is a portable health data system, the PHD, that comprises a portable health data storage device, the PDSD, to be carried by a user; and an intermediate electronic system connectable between the PHD and with the portable health data storage device (PDSD).

A database on a remote server is connectable with the intermediate electronic system. A health care facility database is also connectable with the intermediate electronic system.

The portable health data storage device carries medical information related to the user. The medical information is updateable, initially or during use, through connection of the portable health data storage device with at least one database through the intermediate electronic system.

The Portable Health Data (PHD) system can further comprise a backup database connectable with the portable health data storage device through the intermediate electronic system.

The intermediate electronic system can be for example a personal computer, a workstation or a freestanding unit.

There is a method for carrying personal medical information on the portable health data storage device (PDSD). The steps include initializing and updating the portable health data storage device through the uploading of the personal medical information to the portable health data storage device by means of information stored on databases remote from the portable health data storage device.

In particular the initializing and updating steps includes the step where the medical information can transit through an intermediate system and there is preferably an enablement permitted by means of a decoding key. The decoding key is preferably a personal identification number (PIN).

In a preferred embodiment of the method the medical information is encrypted to safeguard the patient privacy.

The PHD system and method of the present disclosure also allows the transfer of personal health and medication history between different medical institutions in a manner compliant with existing Health Insurance Portability and Accountability Act (HIPAA) regulations.

### BRIEF DESCRIPTION OF THE DRAWINGS

FIG. 1 shows a perspective view of the portable health data storage device of the disclosure.

FIG. 2 is a diagram showing the Portable Health data System according to the disclosure.

FIGS. 3-5 show different embodiments of the intermediate electronic system according to the disclosure.

### DETAILED DESCRIPTION OF THE DISCLOSURE

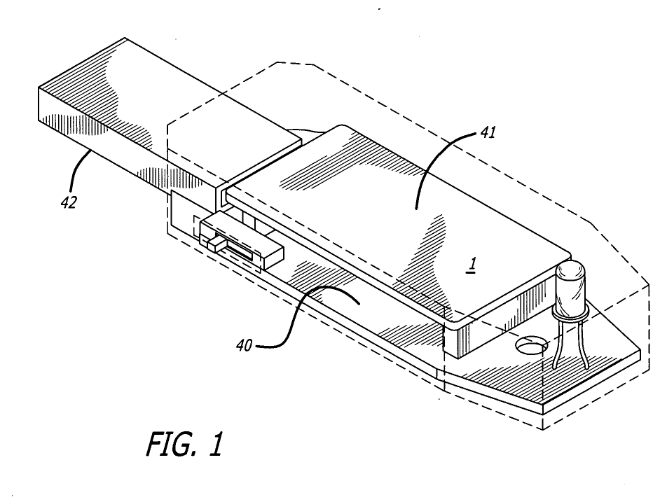

FIG. 1 shows the PDSD (1) according to the present disclosure.

The PDSD (1) is a compact electromagnetic/optical/chip memory data storage device using existing technology, for example USB drive/key chain combo (such as a jump drive portable USB storage device), a secure-data card and can include a multi-media card. In particular the portable health data storage device of the present disclosure comprises a main circuit board (40), a memory circuit board, circuit, chip or device (41) connected to the main circuit board chip or circuit and a serial bus port (42) as described for instance in U.S. Pat. No. 6,490,163, which is incorporated herein by reference. The main circuit board circuit chip or device may be programmed and can provide the control functions for in/out transfer of data between the port and the memory board chip or device, drive functions of the device and other control functions as may be necessary.

The jump drive generates significant payoffs in convenience, maintenance, and security. The jump drive is portable, pocket-sized lightweight and invariably does not require a special drive to work with a PC.

A jump drive is a compact, removable drive that attaches to the PC via a USB port, and adds anywhere from 16 Mbyte to more than 4 Gbyte of portable storage to the system. In operation, the drive is like an ordinary floppy or hard drive. The device may be self-bootable with a PC so as to allow booting from a USB device. There are different types of compact, portable USB drives. The smaller-capacity variants are sealed units about the size of a normal adult thumb. These units have no moving parts, and emulate the operation of a disk drive via solid-state electronics and memory chips that retain data even when the power is removed. The midrange variants are generally two-piece units consisting of a “media reader” device into which you can insert postage-stamp-sized memory chips; the electronics in the reader let the PC access the memory chip as if it were a hard drive. The upper end units use no emulation: they are sealed or semi-sealed units that contain an actual miniaturized hard drive and are the size of a postage stamp. Memory can be from 16 Mbytes to 4 Gbytes or more.

Jump drives have sufficient storage space to hold an entire operating system and are commonly used to transport files and data from PC to PC.

Software can encrypt files one may place on the jump drive. Data is protected thus avoiding a concern that something will be lost in translation. With cross-platform capabilities, a jump drive allows one to effortlessly store and transfer files via the USB port on a computer with no driver installation required.

The portable device stores carries and transfers medical information concerning a user. Given the considerable storage capacity, all, or essentially a voluminous amount, of the data pertaining to a patient, including radiographic readings and studies, can be stored in a single device.

Given the small dimension of the device, its lightweight size and durability, the PDSD (1) of the present disclosure can be easily carried essentially everywhere, if necessary, by the user, who can promptly provide all the user's medical information at a moments notice.

In addition cross platform capabilities allows for the essentially effortlessly transfer of the medical files between every computer systems (even between PC and Mac) without the need of complex extra steps often associated with computer or data input from peripheral devices and without the need of a unique driver installation. Accordingly the medical information can be easily and rapidly transferred via the PDSD (1) from and into any or multiple health care provider systems.

In addition the possibility of encrypting the data stored in the PDSD (1) ensures that the privacy of the patient be safeguarded.

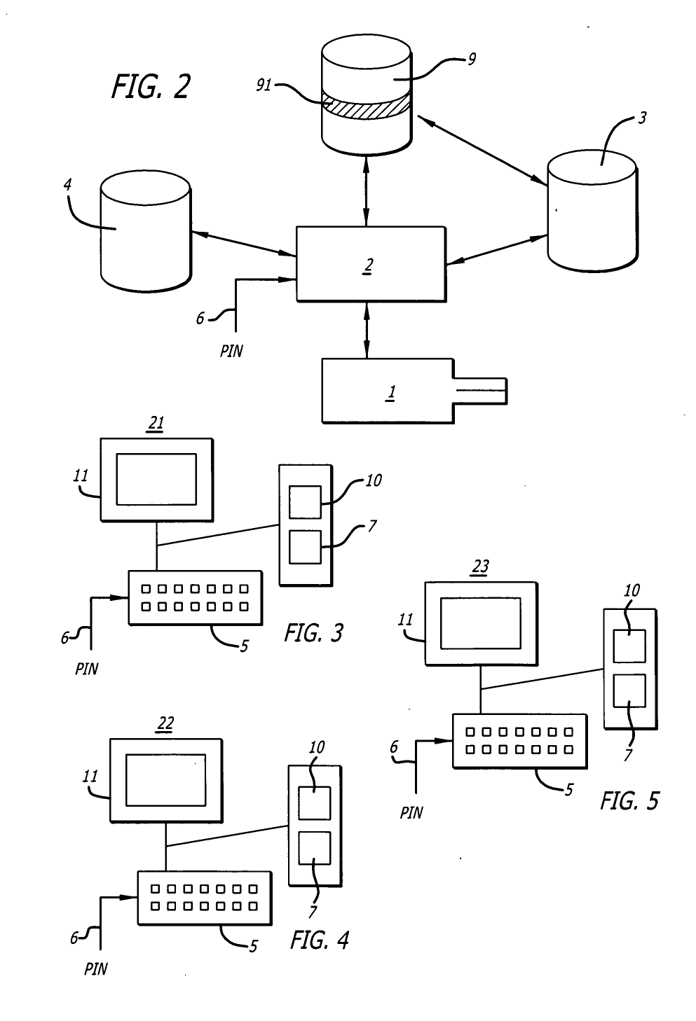

FIG. 2 shows the PHD system according to the present disclosure. The PHD system is based on a portable health data storage device (PDSD) (1) or compact or ultra compact data system to be used in combination with an intermediate electronic system (2), a database on a remote server (9), a health care provider database (3), and a backup database (4).

The PDSD (1) is a compact electromagnetic, and/or optical chip, memory data storage device using existing technology. There is for example a USB drive, selectably with a key chain combination. There can be a secure-data card and in some cases a multi-media card. As this technology is easily identifiable by the person skilled in the art, it does not need to be described here in detail.

The data stored in the PDSD is preferably encrypted, so that the information cannot be extracted without the permission of the owner of the PDSD, i.e. the patient. For example, the information can be extracted by use of a decoding key (6).

The intermediate electronic system (2) is a system that allows transfer of data between the PDSD (1) and a database in an encrypted format. Accordingly, no information can be transferred from/to the PDSD or from/into the database until a decoding key (6), for example a Personal Identification number (PIN) is entered. The database accessed by the intermediate system (2) can be, for example, a database on a remote server (9), a health care facility database (3) or the backup database (4). Additionally, embodiments comprising access to two or more of those databases can also be provided.

The intermediate system according to the present disclosure is now described in detail in FIGS. 3-5 below.

The database on a remote server (9) can be a central database including all data about patients participating in the system. Each patient can access the patient's personal account (91) using, for example, the decoding key or pin (6) via the intermediate system (2). The data can be uploaded or downloaded from or into the database on a remote server (9) via the intermediary system (2) once the decoding key (6) has been provided.

The health care facility database (3) is a database of a health care facility, for example a hospital, a laboratory, a physician, a radiologist or a pharmacist.

The patient's information stored in the PDSD (1) can be uploaded from the PDSD (1) to the database (3) via the intermediate system (2), (for example a workstation described in details in FIG. 3 below). At the same time the patient's record included in the health care facility database (3) can be downloaded to the PDSD (1) after a service, such as hospitalization, laboratory analysis or drug delivery is rendered.

Alternatively, the patient's information can be uploaded from the health care facility database (3) to the patient's account (91) in the database on the remote server (9) where the information can be accessed by the patient and recorded directly into the PDSD (1) via the intermediate system (2).

As a further alternative, the patient can directly access the patient's record in the health care facility database (3) via the intermediary system (2). This can for example be subsequently to having been discharged from a hospital.

The backup database (4) is a database where an updated record of the data stored in the PDSD (1) is kept. Such a database can be a patient's personal computer backup database or a web-based backup database. The web-based backup database can be a personal account for the patient set up in a remote server via the Internet. Preferably, the program used to store information in such a backup database can only be accessed using the patient's decoding key or pin (6).

Data stored in the remote server (9) can be accessed remotely by the patient or by a health care provider once the decoding key (6) is entered. Use of a decoding key (6) allows access of data even in case the patient does not have the PDSD (1) with them.

FIGS. 3-5 show various embodiments of the intermediate system (2) according to the present disclosure.

In all three embodiments, the intermediate system (2) comprises a decoding keypad (5) a read/write drive (7) and connection means (10), for example a modem, to allow connection, for example an Internet connection, between the PDSD (1) and databases (3), (4), or (9) of FIG. 1.

Transfer of information from/to the PDSD, is carried out by entering the decoding key (6) into the keypad (5), thus activating the read/write drive (7) and allowing the rapid transfer of data between the intermediate system (2) and the PDSD (1). The PDSD is removably receivable in the read/write drive (7).

In a first embodiment shown in FIG. 3, the read/write drive (7), the keypad (5) and the connection means (10) includes a Personal Computer (PC) (21), for example the PC of the patient, loaded with a suitable software and including a screen (11).

In a second embodiment shown in FIG. 4, the read/write drive (7), the keypad (5) and the connection means (10) are comprised in a workstation (WS) (22), including a screen (11), for example located in the offices of a health care facility, such as a hospital, a laboratory, a physician's office, a radiologist's office, or a pharmacist's office.

In a third embodiment shown in FIG. 5, the read/write drive (7), the keypad (5) and the connection means (10) are all located in a Free Standing Unit (FSU) (23) that has a screen or a built-in display (30) and a storage setup (not shown in the Figure) that allows the FSU to run suitable software to allow transfer of data from/to the PDSD (1).

This system is preferably compatible with Current Procedure Terminology (CPT) and International Classification of Diseases and Operation, 9th edition (ICD-9) codes, to allow a smooth sharing of data with currently existing medical data codification methods.

The PHD system allows additional information, such as insurance registration, dates of recent office visits, different practitioner names, addresses and phone numbers, patients' pharmaceutical history, medication allergies, lab and radiographic studies, to also be transferred from and into the PDSD (1).

The system according to the present disclosure will be better understood with reference to the following non-limiting examples, provided for illustration purposes only.

### EXAMPLES

### Example 1

### Patient Data Entry Process

An initial PDSD is formatted so as to be clean or clear of medical data.

The PDSD can be purchased by a patient from an authorized physician office, an insurance carrier, from the Internet, or from a pharmacy outlet.

Initial data entry into the PDSD can be performed by the patient either at home using an Internet-based program that can communicate with either a USB port or a drive that supports another data storage system.

Patients can also have the PDSD device shipped to them after entering their information online.

The initial data entry program can be a window-based, user-friendly system which takes the patient through the programming process with relative ease.

Patients can help their programming process by requesting a copy, preferably electronically, of their medical records from their physician or physicians.

A printout of the data entered into the PDSD can be provided to the patient's physician to verify the accuracy of the data and also allow physicians, who do have an intermediate system, for example a workstation, in their facility to have rapid access to a brief summary of the patients' medical history.

Patients can choose their PIN in the privacy of their home and the password can be stored in the patients' personal computers or online in the PHD server.

### Example 2

### Hospital PHD System

A brief record of each hospitalization can be downloaded to the PDSD, including the discharge summary, operative records, initial history and physical examination.

A summary of the laboratory studies as well as radiographic studies can also be stored into the PDSD.

Hospitals can have the option of allowing patients to connect to their hospital databases (health care database) securely and possibly in encrypted form to permit for an easy access to the patient's records after discharge. This is useful because in most cases the discharge summaries and operative records are not ready for download when the patient leaves the hospitals.

Hospital coders will also be able to submit information to the exact ICD-9 codes and CPT codes so that also the codes can be placed into the PDSD.

Hospital encounters can also be uploaded to the patient's account or data (91) located on the PDSD server (9) via the Internet.

### Example 3

### Laboratory PHD System

Laboratory studies ordered for a patient can be recorded on the PDSD storage device.

Laboratory results may be recorded onto the PDSD if the results are readily available. The PHD system can use either direct emulation or an uploading method whereby the data is uploaded to the patient's account on a remote server via the Internet. This data can then be accessed by the patient directly and recorded directly onto a PDSD.

Laboratory results can also include surgical pathology and cytopathology readings.

### Example 4

### Radiology PHD System

A radiology study ordered for a patient can be recorded on the PDSD.

Radiographic readings may be recorded onto the PDSD if the results are readily available. Also in this case, the PDSD system can use either direct emulation or an uploading method whereby the summary of the radiographic study can be sent to the patient's account in a remote server via the Internet. The patient can then download this reading by accessing the patient's PHD Internet account and record the information directly to the PDSD.

### Example 5

### Pharmacy PHD System

A record of patient's medication can be kept on the PDSD.

Updates can be loaded at the physician's office or at a pharmacy that supports the PHD system.

The PHD system can also minimize any potential risk of drug-to-drug interaction by uploading patients existing medication history to the proprietary computer system.

The PHD system can also keep a list of medications that a patient is allergic to and a printout can be generated either by the patient at home or even at any Internet accessible terminal with a printer.

The PHD system can keep a close tab on the patient's medication refill history and help to reduce cost for the government if medications become a covered benefit of Medicare.

The personal health data is stored on the PDSD in a special file sequence and format. Thus, radiology, pharmaceutical, health profiles, personal profiles are separately stored. Different file formats are arranged appropriately such as text files, gif files, pdf files, jpg files, doc files, wp files, tiff files. The files can be cross-referenced, linked, accessed or associated in a useful medically accessible format so that a computer into which the PDSD is plugged can conveniently access the files. Programs on the computer can effectively associate different file formats to assist medical practitioners.

The present disclosure has been described with reference to embodiments given for exemplary, non-limitative purposes. In particular other devices and storage medium such as CD/DVD read write media or possible other forms of optical storage medium identifiable by a person skilled in the art could be used in the systems and methods of the disclosure. The disclosure is directed to users, namely carriers of the storage device being able to transport the device in a user-friendly manner. In turn, the device is easily connected with different computer systems. The USB connection facility is particularly user friendly and effective for this purpose. Accordingly, USB connectable and portable storage devices are particularly advanced.

Upon reading of the present disclosure, the person skilled in the art will recognize alternative embodiments and will understand that the scope of the present disclosure is determined by the appended claims.

1. A portable health storage device for a patient and being for use in a portable health data system having an intermediate electronic system connectable with the portable health data storage device; a database on a remote server, connectable with the intermediate electronic system; and a health care facility database, connectable with the intermediate electronic system, the portable health data storage device comprising:
a main circuit;
a memory connected to the main circuit; and
an input/output facility;
the portable health data storage device being intended to be carried by a patient; and
wherein the portable health data storage device is for carrying medical information related to the patient, the medical information being updateable, initially or during use, through connection of the portable health data storage device with at least one database through the intermediate electronic system.

2. A portable health storage device for a patient and being for use in a portable health data system having an electronic system connectable with the portable health data storage device; a database on a remote server, connectable with the electronic system; and a health care facility database, connectable with the electronic system, the portable health data storage device comprising:
a memory; and
an input/output facility;
the portable health data storage device being intended to be carried by a patient; and
wherein the portable health data storage device is for carrying medical information related to the patient, the medical information being updateable, initially or during use, through connection of the portable health data storage device with at least one database through the electronic system.

3. A portable health storage device for a patient and being for use in a portable health data system having an electronic system connectable with the portable health data storage device; a database on a server connectable with the electronic system; and a health care facility database connectable with the electronic system, the portable health data storage device comprising:
a JumpDrive portable USB storage unit having:
a main circuit;
a memory connected to the main circuit; and
an input/output facility;
the portable health data storage device being intended to be carried by a patient; and
wherein the portable health data storage device is for carrying medical information related to the patient, the medical information being updateable, initially or during use, through connection of the portable health data storage device with at least one database through the electronic system.

4. The portable health storage device according to claim 1, wherein the device is a JumpDrive portable USB storage device.

5. A portable health storage device suitable for use in a method for carrying personal medical information on a portable health data storage device comprising:
a main circuit board;
a memory circuit board connected to the main circuit board; and
a serial bus port;
the method comprising steps of initializing and updating the portable health data storage device through upload of the personal medical information to the portable health data storage device by means of information stored on databases remote from the portable health data storage device.

6. The portable health storage device according to claim 5, wherein the device is a JumpDrive portable USB storage device.

7. A portable health data system, comprising:
a portable health data storage device to be carried by a user;
an intermediate electronic system connectable with the portable health data storage device;
a database on a remote server, connectable with the intermediate electronic system; and
a health care facility database, connectable with the intermediate electronic system;
wherein the portable health data storage device is for carrying stored medical information related to the user, the medical information being updateable, initially or during use, through connection of the portable health data storage device with at least one database through the intermediate electronic system.

8. The portable health data system according to claim 7, further comprising a backup database connectable with the portable health data storage device through the intermediate electronic system.

9. The portable health data system according to claim 7, wherein the intermediate electronic system is a personal computer.

10. The portable health data system according to claim 7, wherein the intermediate electronic system is a workstation.

11. The portable health data system according to claim 7, wherein the intermediate electronic system is free standing unit.

12. The portable health data system according to claim 7, wherein the portable health data storage device is a JumpDrive portable USB storage device.

13. A method for carrying personal medical information on a portable health data storage device comprising steps of initializing the portable health storage device; and updating the portable health data storage device through upload of the personal medical information to the portable health data storage device by information stored on databases remote from the portable health data storage device.

14. The method of claim 13, wherein, during the initializing and updating steps, medical information transits through an intermediate system.

15. The method of claim 13 wherein the initializing and updating steps are enabled by activation of a decoding key.

16. The method of claim 15, wherein the decoding key is a personal identification number (PIN).

17. The method of claim 13, wherein the medical information is encrypted.

18. The method of claim 7, wherein the portable health data storage device is a JumpDrive portable USB storage device.

19. A portable health storage system comprising:
a portable health data storage device including:
a memory;
an input/output facility; and
the portable health data storage device being intended for portability by a patient;
an intermediate electronic system connectable with the portable health data storage device;
a database on a remote server, connectable with the intermediate electronic system; and
wherein the portable health data storage device carries medical information related to the patient, the medical information being updateable, initially or during use, through connection of the portable health data storage device with at least one database through the intermediate electronic system.

20. The portable health storage device according to claim 19, wherein the device is a JumpDrive portable USB storage device.

21. A portable health storage system comprising:
a portable health data storage device including:
a memory; and
an input/output facility;
the portable health data storage device being intended for portability by a patient;
an intermediate electronic system connectable with the portable health data storage device;
a health care facility database, connectable with the intermediate electronic system,
wherein the portable health data storage device carries medical information related to the patient, the medical information being updateable, initially or during use, through connection of the portable health data storage device with at least one database through the intermediate electronic system.

22. The portable health storage device according to claim 19, including multiple different databases, and wherein at least one database is selectively interactive with the device through the Internet.

23. The portable health storage device according to claim 20, including multiple different databases, and wherein at least one database is selectively interactive with the device through the Internet.

24. The portable health storage device according to claim 21, including multiple different databases, and wherein at least one database is selectively interactive with the device through the Internet.
